(19) United States
(12) Patent Application Publication
(10) Pub. No.: US 2007/0136515 A1
(43) Pub. Date: Jun. 14, 2007

(54) Formatting of optical discs

(76) Inventors: Peter Alfred Newman, Beckshire (GB); Philippe Marcel Henri Selve, Wokingham (GB); Victor Kovner, Maidenhead (GB)

Correspondence Address: PATENT DEPARTMENT;MACROVISION CORPORATION, 2830 DE LA CRUZ BLVD., SANTA CLARA, CA, 95050, US

(21) Appl. No.: 10/577,217

(22) PCT Filed: Nov. 3, 2004
(86) PCT No.: PCT/GB04/04658

§ 371 Date: Apr. 26, 2006

(30) Foreign Application Priority Data
Nov. 3, 2003 (GB) 0325601.3

(51) Int. Cl. G06F 13/00

(52) U.S. Cl. 711/111

(57) ABSTRACT

Conventionally, multiple session discs are provided with backward going pointers (P). It is now disclosed that it is possible to navigate a multiple session disc without the provision of such pointers (P). A multiple session optical disc which also acts to copy protect audio data has a first audio session (40) and a second data session (60). The data session (60) has a Lead-In (LI), a program area (32), and a Lead-Out (LO). It also has a primary volume descriptor (50) containing control data identifying the files within the data session but there is no pointer from the Lead-Out (LO) of the session (60) to any part of the program area (32). The audio session (40) has a program area (32) extending between the Lead-in (LI) and the Lead-Out (LO). To copy protect the audio information, the audio data (40) is hidden from a data reader. For example, the Lead-In (LI) to the audio session (40) and the Lead-In (LI) to the data session (60) may each erroneously identify the data in the audio session as data.

The present invention relates to an optical disc carrying content and control data in at least two sessions and to a method of recording content and control data onto an optical disc in at least two sessions.

EP-B-0507403 describes a method of recording content in multiple sessions onto a record carrier, such as an optical disc, to facilitate the navigation of the disc.

In the format described in the above identified patent, control data from all of the earlier sessions is copied into each subsequent session. In a commercial format, the Lead-Out of the last session on the disc includes control data identifying the existence of earlier sessions together with control data specific to the last session. For fast navigation of the disc a pointer is provided from each Lead-Out which references or addresses control data of that session. For example, there is generally provided a pointer from the Lead-Out of each session which references the primary volume descriptor of that session.

The present invention seeks to provide different formats for multiple session optical discs.

According to a first aspect of the present invention there is provided an optical disc carrying content and control data for enabling access to the content, the content being arranged on the disc in at least two separate and consecutive sessions, wherein each session on the disc has a Lead-In, a program area, and a Lead-Out, and wherein none of the sessions has a pointer from the Lead-Out which references control data of that same session.

Specifically, with an optical disc of embodiments of the invention, none of the sessions has a pointer from the Lead-Out thereof which references or addresses the primary volume descriptor of that same session.

The format of embodiments of this first aspect of the invention is simpler than that conventionally provided for multiple session discs and yet a data reader is able to reliably navigate the disc. If the number of sessions is kept low, for example, to five or less, there is unlikely to be any noticeable degradation in the time taken to navigate the disc as compared to the conventional format.

Thus, it is now suggested that the use of backward going pointers from Lead-Outs to control data, which had previously been thought to be essential to navigate a multiple session disc, are not required. Furthermore, where the multiple session disc has a restricted number of sessions, for example, two only, the change of format is not apparent to a user.

In accordance with a specific embodiment of the invention, a multiple session optical disc comprises a plurality of individual sessions arranged sequentially along a spiral track of the optical disc from an inner area to an outer area thereof, wherein each said session has a Lead-In, a program area and a Lead-Out, and wherein none of the sessions has a pointer from the Lead-Out which references or addresses the program area of that same session.

Preferably, the first session on the optical disc which extends from the inner area thereof is an audio session having audio data contained in the program area.

The session or sessions following the first session are each data sessions and the or each has a primary volume descriptor in its program area. However, there are no pointers provided from the Lead-Out of each data session which reference or address the primary volume descriptor of that session.

According to a further aspect of the present invention there is provided an optical disc carrying content and control data for enabling access to the content, the content being arranged on the disc in at least two separate and consecutive sessions, wherein each session on the disc has a Lead-In, a program area, and a Lead-Out, and wherein information in the Lead-In to a session used to identify the format of the session is preset irrespective of the format of the session.

The format of embodiments of this further aspect of the invention is simpler than that conventionally provided for multiple session discs and yet a data reader is able to reliably navigate the disc.

The Lead-In of each session is conventionally defined by Q-data in Mode 1 and when POINT in the Lead-In is $A0, Psec in the Lead-In identifies the format of a session. In an embodiment, irrespective of the format of a session, when POINT is $A0 Psec in the Lead-In for that session is set to 00.

The present invention is particularly applicable to a copy protected audio disc having a first audio session and at least one subsequent data session.

For example, and as described in WO 03/034424, the first session on the disc is an audio session having a program area containing audio data, and control data in the second and subsequent sessions which relates to the first session has been removed, corrupted, rendered incorrect and/or inaccurate or otherwise interfered with.

By interfering with control data in the second and subsequent sessions which describes the first session, the first audio session can be effectively ‘hidden’ from a data reader.

The control data to which interference has been applied may be provided in the Lead-In to a session, for example, in the Table of Contents (TOC), and/or may be included in, or constituted by, other navigation and/or timing data generally.

For example, in the Lead-In to each session the audio data in the audio session may be erroneously identified as data rather than audio.

In an embodiment, the control data to which interference has been applied is provided in one or more descriptors for the information. For example, the control data may be in a primary volume descriptor. Additionally and/or alternatively, the control data may be in a secondary volume descriptor. In addition, and/or as an alternative, the control data may be in one or more directories.

Additionally, and/or alternatively, the control data to which interference has been applied may be address information.

Additionally, and/or alternatively, the control data to which interference has been applied may be navigation and/or timing data.

In a preferred embodiment, the content and control data is arranged on the optical disc in two sessions only, a first session being an audio session in which the program area contains audio data, and the second session being a data session, and wherein the second data session has a primary volume descriptor including control data enabling access to data in the program area of the second session, and where there is no pointer referencing the primary volume descriptor from the Lead-Out of the second session.

The first and second sessions are arranged sequentially along a spiral track extending along the optical disc from an inner area thereof to an outer area thereof, the first session having its Lead-In at the inner area and the Lead-Out of the second session being at said outer area.

The present invention also extends to a method of recording content and control data onto an optical disc, the method comprising the steps of arranging the content on the disc in at least two separate and consecutive sessions, where each session has a Lead-In, a program area, and a Lead-out, the method comprising the step of recording the content and control data on the optical disc such that none of the sessions has a pointer from the Lead-Out thereof which references any control data of that same session.

Specifically, content and control data is recorded on the optical disc such that none of the sessions has a pointer from the Lead-Out thereof which references or addresses the primary volume descriptor of that same session.

According to a further aspect of the present invention there is provided a method of recording content and control data onto an optical disc, the method comprising the steps of arranging the content on the disc in at least two separate and consecutive sessions, where each session has a Lead-In, a program area, and a Lead-Out, the method comprising the step of recording the content and control data onto the optical disc such that information in the Lead-In of a session used to identify the format of the session is preset irrespective of the format of the session.

Conventionally the Lead-In of each session is defined by Q-data in Mode 1 and when POINT in that Lead-In is $A0, Psec in the Lead-In identifies the format of the session. In an embodiment, the method further comprises, irrespective of the format of the session, when POINT is $A0 setting Psec in the Lead-In to the session to 00.

In embodiments of the method of the invention, content and control data is recorded onto an optical disc to provide a copy protected audio disc having a first audio session and at least one subsequent data session.

For example, the first session on the disc is recorded as an audio session having a program area containing audio data, and control data recorded in the second and subsequent sessions which relates to the first session has been removed, corrupted, rendered incorrect and/or inaccurate or otherwise interfered with.

By interfering with control data in the second and subsequent sessions which describes the first session, the first audio session can be effectively ‘hidden’ from a data reader.

In embodiments of a method of the invention, the control data to which interference has been applied may be provided in the Lead-In to a session, for example, in the Table of Contents (TOC), and/or may be included in, or constituted by other navigation and/or timing data generally.

Embodiments of the present invention will hereinafter be described, by way of example, with reference to the accompanying drawings, in which:

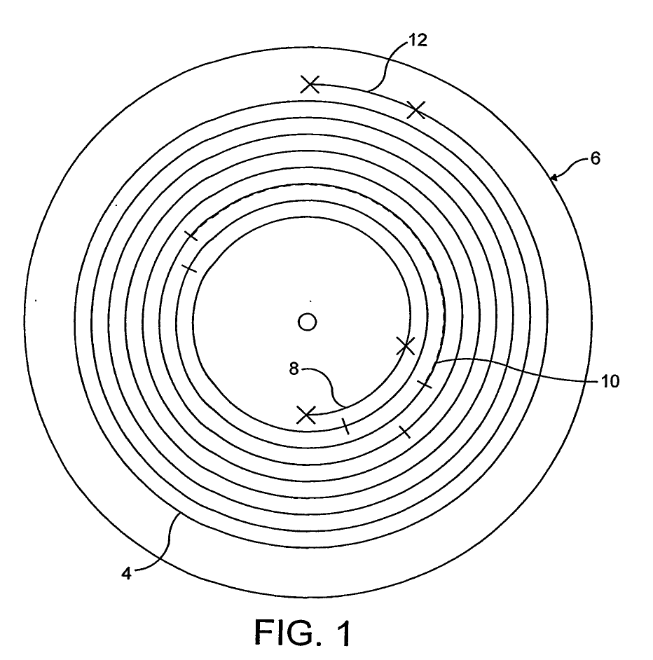

FIG. 1 shows schematically a compact disc showing the spiral data track,

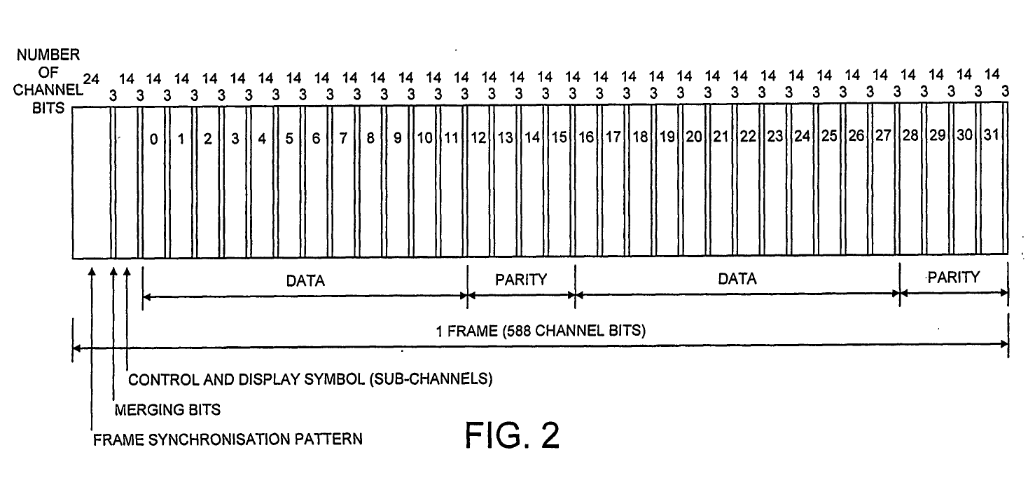

FIG. 2 shows the structure of a frame of data encoded on a CD,

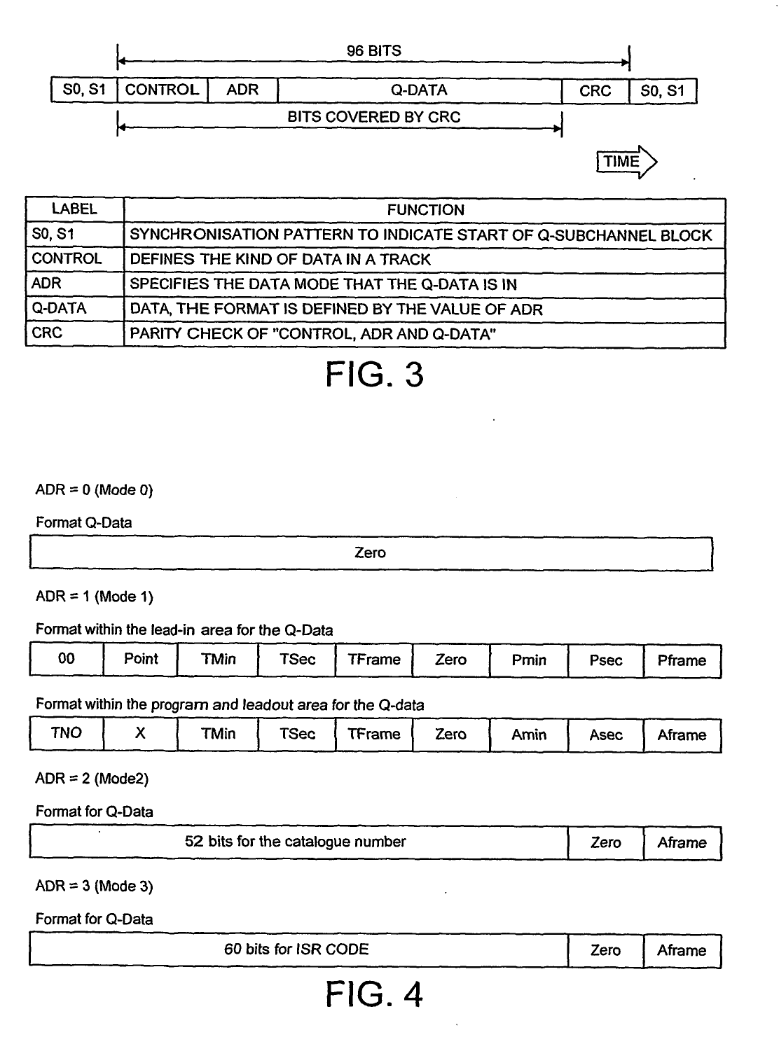

FIG. 3 illustrates the general data format of the Q-subchannel,

FIG. 4 shows the format of the data for the Q-subchannel according to mode,

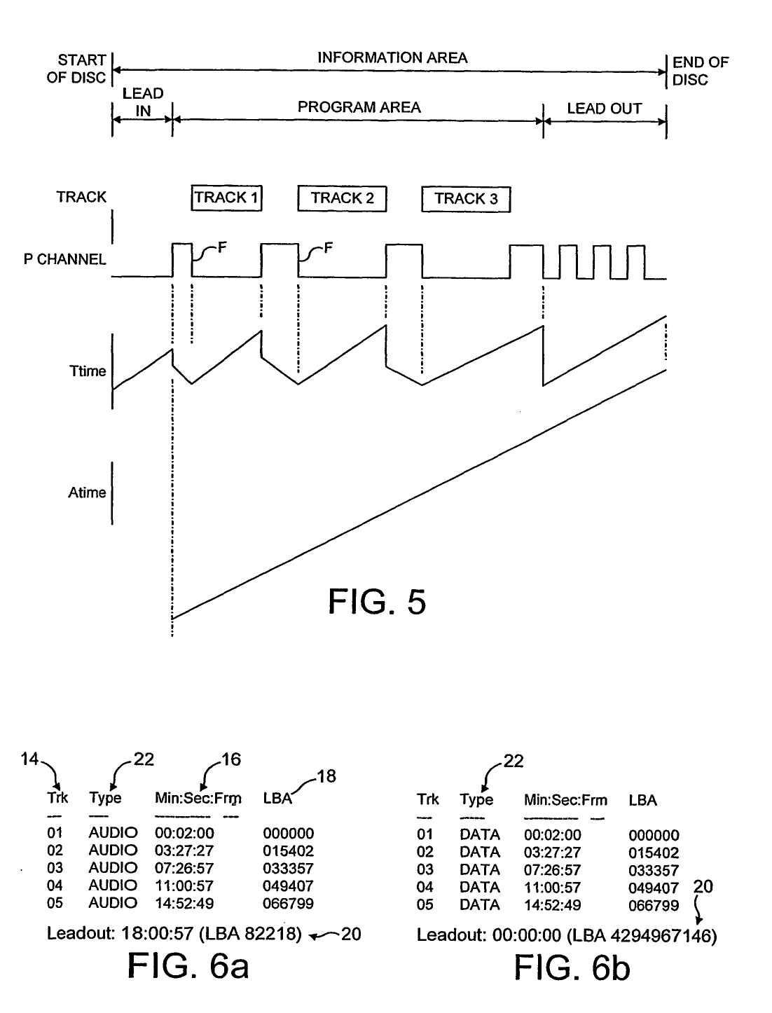

FIG. 5 shows graphically both Atime and Ttime on a compact disc,

FIG. 6a shows an example of the track definition, with the Table of Contents, of a CD-DA,

FIG. 6b shows the Table of Contents of the CD-DA of FIG. 6a when the disc has been copy protected,

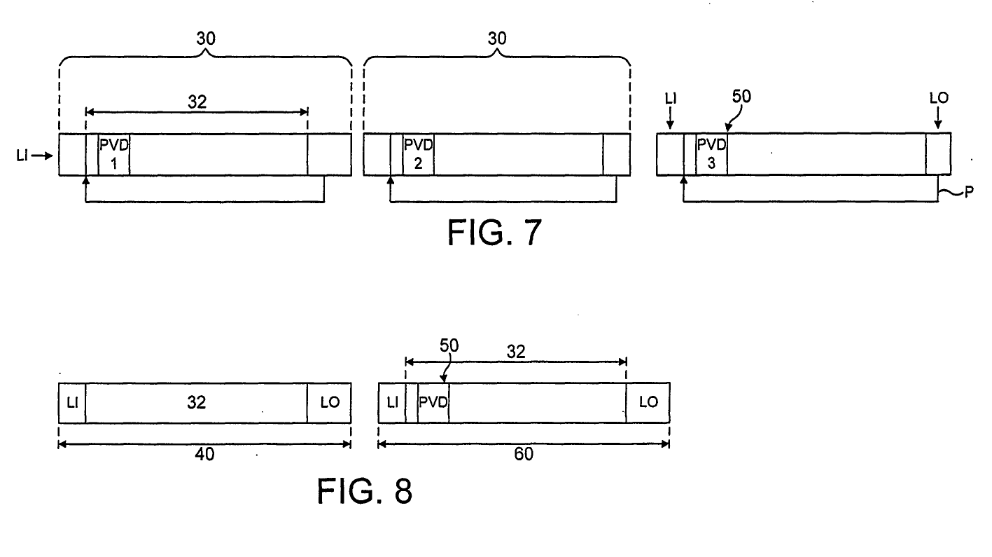

FIG. 7 shows a substantially conventional optical disc having multiple sessions illustrating schematically the format of the content and control data,

FIG. 8 shows an embodiment of a multiple session optical disc of the present invention illustrating schematically the format of the content and control data, and

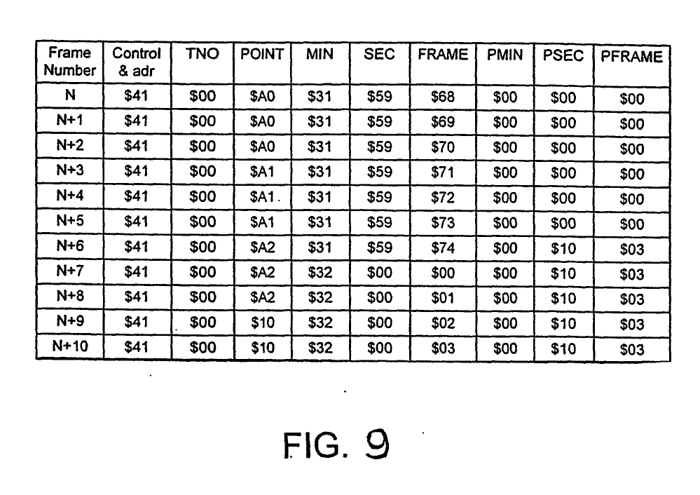

FIG. 9 shows the encoding of the TOC in the Lead-In area of the second session of a multiple session optical disc in accordance with an embodiment of the present invention.

A digital audio compact disc (CD-DA), which carries music and is to be played on an audio player such as a conventional CD disc player, is made and recorded to a standard format known as the Red Book standards. As well as defining physical properties of the disc, such as its dimensions, and its optical properties, such as the laser wavelength, the Red Book also defines the signal format and the data encoding to be used.

As is well known, the Red Book standards ensure that any CD-DA produced to those standards will play on any audio player produced to those standards.

FIG. 1 shows schematically the spiral track 4 on a CD 6. This spiral track 4 on a CD-DA is divided into a Lead-In 8 at an inner area of the disc, a number of successive music or audio tracks as 10, and a Lead-Out 12 at an outer area of the disc. The Lead-In track 8 includes a Table of Contents (TOC) which identifies for the audio player the tracks to follow. The Lead-Out 12 gives notice that the track 4 is to end.

An audio player always accesses the Lead-In track 8 on start up. The music tracks may then be played consecutively as the read head follows the track 4 from Lead-In to Lead-Out. Alternatively, the player navigates the read head to the beginning of each audio track as required.

Generally, compact disc players are programmed not to move the read head beyond the start of the Lead-Out track 12. This is to protect the read head.

To the naked eye, a CD-ROM looks exactly the same as a CD-DA and has the same spiral track divided into sectors. However, data readers, such as CD-ROM drives, are much more sophisticated than compact disc players and are enabled to read data, and process information, from each sector of the compact disc according to the nature of that data or information. A data reader can navigate by reading information from each sector whereby the read head can be driven to access any appropriate part of the spiral track 4 as required.

To ensure that any data reader can read any CD-ROM, the compact discs and readers are also made to standards known, in this case, as the Yellow Book standards. These Yellow Book standards incorporate, and extend, the Red Book standards. Hence, a data reader, such as a CD-ROM drive, can be controlled to play a CD-DA.

As the data encoding on a CD-DA and on a CD-ROM is well known and in accordance with the appropriate standards, it will only be briefly described herein.

The data on a CD is encoded into frames by EFM (eight to fourteen modulation). FIG. 2 shows the format of a frame, and as is apparent therefrom, each frame has sync data, sub-code bits providing control and display symbols, data bits and parity bits. Each frame includes 24 bytes of data, which, for a CD-DA, is audio data.

There are 8 sub-code bits contained in every frame and designated as P, Q, R, S, T, U, V and W. Generally only the P and Q sub-code channels are used in the audio format. The standard requires that 98 of the frames of FIG. 2 are grouped into a sector, and the sub-code bits from the 98 frames are collected to form sub-code blocks. That is, each sub-code block is constructed a byte at a time from 98 successive frames. In this way, 8 different subchannels, P to W, are formed. These subchannels contain control data for the disc. The P- and Q-subchannels incorporate timing and navigation data for the tracks on the disc, and generally are the only subchannels utilised on an audio disc.

The data format for a Q-subchannel block assembled from 98 successive frames is indicated in FIG. 3. As is apparent, the start of the subchannel block is indicated by the appearance of sync patterns S0 and S1 as the first 2 symbols. The next data bits are control bits to define the contents of a track. Thus, the control bits might identify audio content or data content. There then follows address information, ADR, which specifies one of four modes for the Q-data bits. 72 bits of Q-data succeed the address information, and then there are 16 CRC, or check, bits which are used for error detection on the control, address and Q-data bits.

FIG. 4 illustrates the data content of a Q-subchannel block in each of the four modes designated by the address information, ADR. In Mode 0, all of the Q-data has a value of zero. In Mode 2, the Q-data comprises a catalogue number for the disc, such as a bar code of the Universal Product Code In addition, in Mode 2 the Aframe component of the time count from adjacent blocks is continued. Mode 3 is used to give ISR code for identifying each music track. In addition, and as is illustrated, in Mode 3 the absolute time count, Atime, is continued.

As indicated in FIG. 4, in Mode 1 the Q-data in each subchannel block contains program and time information for individual audio tracks and for the information area of the disc. As is illustrated, there is a different format for the Q-data for the Lead-In area to that within the program and Lead-Out areas. However, in both formats in Mode 1, the Q-data gives information as to the time along a track. The running time of a track is referred to as the Ttime, is in minutes, seconds and frames, and TMin, TSec and TFrame are all components of Ttime. In the program and Lead-Out areas, the Q-data additionally includes information about the absolute time, Atime, on the disc in minutes, seconds and frames, and Amin, Asec and Aframe are all components of Atime.

The Mode 1 Q-data in the Lead-In area provides the Table of Contents (TOC). FIG. 9 indicates the encoding of part of the TOC in the second session of a multiple session disc. As is indicated in FIG. 9, in the TOC items are repeated thee times in successive Q-subchannel blocks and the complete TOC is continuously repeated during the Lead-In area. Within the Lead-In area for the Q-subchannel data the items Min, Sec, Frame identify the absolute or Atime. When POINT is any value between 01 and 99, Pmin, Psec and Pframe contain the start address of the track pointed to by POINT.

When POINT is set at $A0, Pmin contains the first track number in the program area whilst Psec specifies the session format. As set out below, the session can be an audio session or one of various types of data sessions.

When POINT is set to $A1, Pmin contains the track number of the last track in the program area, and when POINT is set to $A2, Pmin, Psec and Pframe give the start address of the Lead-Out area. As specified above, it is the control bits which identify the nature of the data within the program area. Generally when CONTROL is set to 0 it indicates an audio track.

FIG. 5 shows graphically how Atime and Ttime vary across a disc. Atime is the absolute time across the disc and starts at zero at the beginning of the program area. Ttime is the running time within each track and thus starts at zero at the beginning of each track. Thus, and as illustrated in FIG. 5, Atime increases monotonically across the disc whilst Ttime increases along each individual track. As is also illustrated in FIG. 5, the P-subchannel includes flags F which each indicate the start of a respective track. The P-subchannel flags also designate the Lead-Out area.

As indicated in FIG. 4, in Mode 1 each Q-subchannel block contains the next consecutive values for Atime and Ttime. When an audio player is to play an audio track, the head is navigated to the start of the track. The navigation may be by way of the Atime, the Ttime, and/or the P-subchannel flags, or by some combination thereof. In general, once an audio player has started playing a track, it will continue.

As set out above, the Mode 1 Q-data in the Lead-In area provides the TOC. Part of a typical TOC is set out in table form in FIG. 6a. It will be seen therefrom that each track, at 14, is given, at 16, a start address in time and in sectors from the end of the Lead-In. Each track also has a logical block address (LBA) 18 which is calculated from the Atime and provides an address for the start of the track on the disc. The TOC of an audio disc also identifies the Atime from the start of the program area to the start of the Lead-Out as indicated at 20. However, audio players do not generally read or use the Lead-Out time from the TOC.

FIG. 6b shows in table form part of the TOC from FIG. 6a after it has been altered to copy protect the disc by a method as described in WO 00/74053. Specifically, it will be seen that, at 20, the Atime from the start of the disc program area to Lead-Out has been set to zero indicating that the Lead-Out is at the commencement of the pregap of the first audio track. A data reader, therefore, accessing the disc 6 will read from the Lead-In information signifying that the disc does not have a program area and that the Lead-In is directly followed by the Lead-Out. The data reader will refuse to move the read head beyond the start of the audio track because it believes that the first track starts within the Lead-Out. A data reader, therefore, will be unable to read or play the disc with the TOC of FIG. 6b.

Again as described in WO 00/74053, the TOC of FIG. 6b has been altered in a second way which also prevents proper use by a data reader of the information on the disc. In this respect, and as is apparent from FIGS. 6a and 6b, the tracks on the audio disc are all audio tracks as noted at 22. In the TOC of FIG. 6b these tracks have been erroneously identified as data tracks. Thus, the data reader is told that each of the following tracks contains digital data, rather than analog audio. Any reading of those tracks is therefore confused as the player tries to read the data but cannot find the appropriate SYNC or sector headers. Errors therefore result and the reading is unsatisfactory.

The types of data carried on optical discs, and the data formats, have developed since the original CD-DAs were first commercially produced. For example, the content carried by optical discs may now comprise not only audio, numerical, or written data, but video, graphics, programs, computer and other data. Furthermore, optical discs may no longer include just a single information session as shown in FIG. 1 in which content extends between a Lead-In 8 and a Lead-Out 12.

FIG. 7 shows a substantially conventional multiple session optical disc. Such discs were developed, for example, to enable the recording of subsequent content onto recordable optical discs, but the format illustrated in FIG. 7 is also used for pre-recorded multiple session discs. In this respect, further details as to the control of multiple session optical discs and as to their reading is set out in the Orange Book and in EP-B-0507403.

In a multiple session format, a plurality of separate sessions as 30 are arranged sequentially along the spiral track of the disc from the inner area thereof to the outer area thereof. Each session has a program area, generally indicated at 32, between a respective Lead-In LI and a respective Lead-Out LO. Each session 30 may be an audio session or a data session. Each session is provided with appropriate control data and this is generally the same and in the same format as if the session were the only session on the optical disc.

However, to ensure that a data reader is aware of the existence of all of the sessions on the disc, and to ensure that the data reader can navigate all of the sessions, control data from earlier sessions is repeated in subsequent sessions. Thus, the Lead-In LI to the last session of the disc, contains not only Lead-In control data specific to that session but also Lead-In control data from all of the preceding sessions. Similarly, the Lead-Out of each session may additionally include control data from the Lead-Outs of each preceding session, and the Lead-Out of the last session would then include not only control data specific to that last session but control data from the Lead-Outs of all of the preceding sessions. Alternatively, each Lead-Out may include control data identifying the existence of earlier sessions in addition to the control data specific to that session.

A data reader can identify Lead-Outs relatively quickly, for example, by way of the P-subchannel flags described above which designate Lead-Out areas. Therefore a data reader generally navigates a multiple session optical disc by reference to the Lead-Outs. Thus, when a disc is first loaded, a data reader will go to the Lead-In to the first session and will then scan forwardly to identify the Lead-Out to that first session. As sessions are sequential, the data reader can then navigate from the Lead-Out to the Lead-in to the next session. The data reader can then repeat these steps to thereby access, by way of the Lead-Outs of successive sessions, the Lead-Out of the final session. In this respect, it is conventional that when reading a CD a data reader will access the Lead-Out of the very last session first.

Where the multiple session disc is pre-recorded, a pointer may be provided in the Lead-in to the first session which addresses or references the Lead-Out to the last session. This enables the data reader to navigate quickly and readily to the Lead-Out to the last session.

As we have seen above, there are standards as to the structure of the content recorded on optical discs. One such standard is the ISO 9660 standard which sets down the arrangement of content on an optical disc and requires the provision of standard indexes to describe the contents of a data session.

Briefly, the content in the data session or sessions is arranged in files. The interrelationship of each file with other files, and the location and attributes of the files are recorded in directories. These directories are arranged in a hierarchical relationship with a root directory and a plurality of other sub-directories. The files and directories together constitute a volume which additionally includes volume descriptors, directory descriptors and file descriptors. The descriptors contain descriptive information about the corresponding volume, directories and files and also contain information as to the structure of the volume. To enable all of the content in the volume to be accessed, each directory is identified in at least one other directory, and the root directory is identified either in a primary volume descriptor (PVD) or in a supplementary volume descriptor (SVD).

The ISO 9660 standard is well known and need not be further identified herein. Full details of the technically identical ECMA-119 are available at www.ecma.ch.

The standard requires that the primary volume descriptor (PVD) 50 occurs after the standard Lead-In LI of a data session as 30. Thus, on a multiple session disc as shown in FIG. 7, the PVD 50 of each data session 30 is provided immediately after sector 15 in the program area 32 of the session, that is, there are 16 sectors from the commencement of the program area 32 to the PVD 50.

As described above, when a data reader accesses an optical disc it navigates first to the Lead-Out LO of the last session and then it scans forwardly to find the PVD 50 of that session. The PVD 50 provides information as to the files in the last session, and also as to the files in earlier sessions whereby the data reader is enabled to access the data on the disc.

As illustrated in FIG. 7, in conventional multiple session discs, a backward going pointer P is provided which points to sector zero in the program area 32 of that session. The data reader then moves forwardly sixteen sectors to get to the relevant PVD 50. The pointer P may be configured as a sector address provided in the Lead-Out LO of the session which references sector zero in the program area 32 of that session.

All multiple session discs are provided with backward going pointers, for example, as P and it is generally considered by those skilled in the art that it is not possible to reliably navigate a multiple session disc in an acceptable time frame without the use of such backward going pointers.

However, the applicants have now appreciated that it is possible to navigate a multiple session disc without the provision of the pointers P. Omitting the pointers simplifies the format of the content and control data on the disc.

Thus, a format of a multiple session optical disc of the invention comprises sequential multiple sessions which extend along the spiral track of the optical disc from an inner area thereof to an outer area thereof. The format of each session may be as is conventional, and in particular each session has a Lead-In, a Lead-Out and a program area. Appropriate control data, such as volume descriptors, may be incorporated within each program area. However, there are no pointers provided from any Lead-Out LO of a session to the program area of the same session.

As we have seen, the Lead-In LI of each session 30 on a multiple session disc is defined by Q-data in Mode 1. The data content of the Lead-In area in Mode 1 is illustrated in FIG. 4. The Red Book, CDROM XA and all CD standards require that when POINT is set to $A0 Psec specifies the format of the session. According to the standards an audio session (CD-DA) is identified by setting Psec to 00. Different types of data formats are identified by setting Psec to other numbers. The CD-ROM data format can also be covered by setting Psec to 00.

The applicants have now appreciated that it is possible to navigate a multiple session disc without identifying the format of data sessions. Omitting information about data formats simplifies the information to be encoded onto the disc.

Thus, in a format of a multiple session optical disc of the invention, in the Lead-In area in Mode 1, when POINT is $A0 Psec is set to 00. This is illustrated, for example, at frames N, N+1 and N+2 in FIG. 9 which shows part of the TOC of a second data session. It will be seen that in each of these frames N, N+1, N+2 the address information, ADR is Mode 1, that POINT is $A0 whereby Psec specifies the session format, and that Psec is set to 00. Even though the data format specified in the Lead-In LI differs from the format of the data session described by the Lead-In, the disc is still navigable by, and accessible to, a data reader.

The new format in which Psec is predetermined as described above may be used alone, and/or may be used in conjunction with the format in which pointers P are omitted. Furthermore, either or both of the new formats described above may be utilised in combination with any other changed formats.

FIG. 8 shows a preferred embodiment of a multiple session optical disc of the invention which additionally acts to copy protect audio data on the disc. In the embodiment shown in FIG. 8, a copy protected audio disc has just two sessions, namely a first audio session 40 and a second data session 60. The data session 60 has substantially the familiar structure of a Lead-In LI, a program area 32, and a Lead-Out LO. It also has a primary volume descriptor 50 containing control data identifying the files within the data session but, and as is illustrated, there is no pointer from the Lead-Out LO of the session 60 to any part of the program area 32.

The audio session 40 has a program area 32 extending between the Lead-In LI and the Lead-Out LO. However, as this is an audio session, with the program area containing only audio data, there is no PVD in the program area 32 of the first session 40.

It will be appreciated that an audio player, be it a dedicated compact disc music player, or a more sophisticated CD-ROM drive when controlled to play an audio disc, only looks for and uses data encoded to Red Book standards. What is more, if there appears to be an inaccuracy in the data, an audio player will generally continue to play rather than trying to correct the error. For example, if the read head has navigated to the start of a track and commenced to play that track, the audio player will continue to play that track to its end, even if it becomes apparent that there is some error in the information. Thus, an audio player will be able to play the audio in the audio session 40 of the disc illustrated in FIG. 8 in substantially conventional fashion. However, the audio player will not see that there is a second data session 60 provided on the disc.

In the embodiment illustrated in FIG. 8 it is proposed that the audio session 40 be ‘hidden’ from a data reader to copy protect the audio information therein. This copy protection may take any appropriate form. Various examples for copy protecting the audio information are described in WO 03/034424. For example, and as illustrated in FIG. 6b, the Lead-In LI to the audio session 40 may identify the audio as data rather than as audio. This prevents a data reader being able to read the audio data in the program area 32 of the audio session 40. The Lead-In LI to the data session 60 will similarly erroneously identify the data in the audio session as data.

It will be appreciated that other methods of preventing the data reader from reading the audio data in the audio session 40 can be provided. For the copy protection the invention requires only that appropriate control data be rendered incorrect or inaccurate to provide copy protection for any audio data described by that incorrect or inaccurate control data.

Whilst the present invention generally describes new formats for a multiple session CD, it does have, as described above, particular applicability to the protection of CD-DAs. Thus, the copy protection techniques described herein may be used with any or all of the new formats described herein. The optical disc illustrated in FIG. 8 may comprise the audio session 40 which is to be protected together with a dummy data session 60. However, and if required, the data session 60 may alternatively include useful and usable information for a data reader.

It will be appreciated that further modifications and variations to the invention as described and illustrated may be made within the scope of this application as defined by the accompanying claims.

1. An optical disc carrying content and control data for enabling access to the content, the content being arranged on the disc in at least two separate and consecutive sessions, wherein each session on the disc has a Lead-In, a program area, and a Lead-Out, and wherein none of the sessions has a pointer from the Lead-Out which references control data of that same session.

2. An optical disc according to claim 1, wherein none of the sessions on the disc has a pointer from the Lead-Out thereof which references or addresses a primary volume descriptor of that same session.

3. An optical disc according to claim 1, wherein there are between two and five sessions on the disc.

4. An optical disc according to claim 1, wherein the content is arranged on the disc in first and second separate sessions.

5. An optical disc according to claim 1, comprising a plurality of individual sessions arranged sequentially along a spiral track of the optical disc from an inner area to an outer area thereof, wherein each said session has a Lead-In, a program area and a Lead-Out, and wherein none of the sessions on the disc has a pointer from the Lead-Out which references or addresses the program area of that same session.

6. An optical disc according to claim 5, wherein the first session on the optical disc which extends from the inner area thereof is an audio session having audio data contained in the program area.

7. An optical disc according to claim 6, wherein the or each session following the first session is a data session and the or each said data session has a primary volume descriptor in its program area, and wherein there are no pointers provided from the Lead-Out of each data session which reference or address a primary volume descriptor of that session.

8. An optical disc according to claim 7, having a first audio session and at least one subsequent data session, the optical disc being a copy protected audio disc.

9. An optical disc carrying content and control data for enabling access to the content, the content being arranged on the disc in at least two separate and consecutive sessions, wherein each session on the disc has a Lead-in, a program area, and a Lead-Out, and wherein information in the Lead-In to a session used to identify the format of the session is preset irrespective of the format of the session.

10. An optical disc according to claim 9, wherein the Lead-In of each session is defined by Q-data in Mode 1, wherein POINT in the Lead-In is $A0 such that Psec in the Lead-In identifies the format of a session, and, wherein, irrespective of the format of the session, Psec is set to 00.

11. A copy protected audio disc carrying content and control data for enabling access to the content, the content being arranged on the disc in at least two separate and consecutive sessions, wherein each session on the disc has a Lead-In, a program area, and a Lead-Out, and wherein none of the sessions has a pointer from the Lead-Out which references control data of that same session, the copy protected audio disc having a first audio session and at least one subsequent data session, wherein the first audio session has a program area containing audio data, and wherein control data in the second and subsequent sessions which relates to the first session has been removed, corrupted, rendered incorrect and/or inaccurate or otherwise interfered with.

12. A copy protected audio disc according to claim 11, wherein the control data to which interference has been applied is provided in the Lead-In to a session, in the Table of Contents (TOC), and/or is included in, or constituted by, other navigation and/or timing data generally.

13. A copy protected audio disc according to claim 12, wherein in the Lead-In to each session the audio data in the audio session may be erroneously identified as data rather than audio.

14. A copy protected audio disc according to claim 11, wherein the control data to which interference has been applied is provided in one or more descriptors for the information.

15. A copy protected audio disc according to claim 14, wherein the control data to which interference has been applied is in a primary volume descriptor, and/or is in a secondary volume descriptor.

16. A copy protected audio disc according to claim 14, wherein the control data to which interference has been applied is in one or more directories.

17. A copy protected audio disc according to claim 11, wherein the control data to which interference has been applied is in address information.

18. A copy protected audio disc according to claim 11, wherein the control data to which interference has been applied is in navigation and/or timing data.

19. A copy protected audio disc according to claim 11, wherein the content and control data is arranged on the optical disc in two sessions only, a first session being an audio session in which the program area contains audio data, and the second session being a data session, and wherein the second data session has a primary volume descriptor including control data enabling access to data in the program area of the second session, and where there is no pointer referencing the primary volume descriptor from the Lead-Out of the second session.

20. A copy protected audio disc according to claim 19, wherein the first and second sessions are arranged sequentially along a spiral track extending along the optical disc from an inner area thereof to an outer area thereof, the first session having its Lead-In at the inner area and the Lead-Out of the second session being at said outer area.

21. A method of recording content and control data onto an optical disc, the method comprising the steps of arranging the content on the disc in at least two separate and consecutive sessions, where each session has a Lead-in, a program area, and a Lead-Out, the method comprising the step of recording the content and control data on the optical disc such that none of the sessions has a pointer from the Lead-Out thereof which references any control data of that same session.

22. A method of recording content and control data onto an optical disc according to claim 21, wherein content and control data is recorded on the optical disc such that none of the sessions has a pointer from the Lead-Out thereof which references or addresses a primary volume descriptor of that same session.

23. A method of recording content and control data onto an optical disc, the method comprising the steps of arranging the content on the disc in at least two separate and consecutive sessions, where each session has a Lead-In, a program area, and a Lead-Out, the method comprising the step of recording the content and control data onto the optical disc such that information in the Lead-In of a session used to identify the format of the session is preset irrespective of the format of the session.

24. A method of recording content and control data onto an optical disc according to claim 23, wherein the Lead-In of each session is defined by Q-data in Mode 1, and POINT in the Lead-In is $A0 such that Psec in the Lead-In identifies the format of a session, the method further comprising the step of setting Psec to 00 irrespective of the format of the session.

25. A method of recording content and control data onto an optical disc to provide a copy protected audio disc, the method comprising the steps of arranging the content on the disc in at least two separate and consecutive sessions, where each session has a Lead-In, a program area, and a Lead-out, the method comprising the step of recording the content and control data on the optical disc such that none of the sessions has a pointer from the Lead-Out thereof which references any control data of that same session, the method further comprising arranging the content on the disc to provide a first audio session and at least one subsequent data session.

26. A method of recording a copy protected audio disc according to claim 25, further comprising recording the first session on the disc as an audio session having a program area containing audio data, and causing control data in the second and subsequent sessions which relates to the first session to be removed, corrupted, rendered incorrect and/or inaccurate or otherwise interfered with.

27. A method of recording a copy protected audio disc according to claim 26, wherein the control data to which interference has been applied is provided in the Lead-In to a session in the Table of Contents (TOC), and/or is included in, or constituted by other navigation and/or timing data generally.
